(19) United States
(12) Patent Application Publication
(10) Pub. No.: US 2019/0315355 A1
(43) Pub. Date: Oct. 17, 2019

(54) CRUISE CONTROL DEVICE

(71) Applicants: DENSO CORPORATION, Kariya-city (JP); TOYOTA JIDOSHA KABUSHIKI KAISHA, Toyota-shi (JP)

(72) Inventors: Mitsuhiro TOKIMASA, Kariya-city (JP); Takuma SUDO, Kariya-city (JP); Takashi MAEDA, Nagoya-shi (JP); Naoki KUSUMOTO, Okazaki-shi (JP)

(21) Appl. No.: 16/421,954

(22) Filed: May 24, 2019

Related U.S. Application Data
(63) Continuation-in-part of application No. PCT/JP2017/042414, filed on Nov. 27, 2017.

(30) Foreign Application Priority Data
Nov. 29, 2016 (JP) 2016-231781

(51) Int. Cl. B60W 30/16; B60K 31/00

(52) U.S. Cl. CPC B60W 30/16; B60K 31/00; B60W 2550/308; B60W 2420/42; B60W 2750/308; B60W 2720/106; B60W 2550/302

(57) ABSTRACT

A cruise control device applied to a vehicle including a target detection unit and including a following control unit includes a determination unit configured to determine, during the period of execution of following control, whether a small vehicle switching state in which a following target is a small vehicle has occurred or not, an upper limit storage unit configured to store, as an upper limit value, a target acceleration set before determination as the small vehicle switching state by the determination unit under a condition where the determination unit determines that the small vehicle switching state has occurred, and a target acceleration setting unit configured to set the target acceleration to equal to or lower than the upper limit value stored in the upper limit storage unit during a period until the following control performed for the switched small vehicle as the following target ends.

### CROSS-REFERENCE TO RELATED APPLICATION

This application is the U.S. a bypass-continuation in part application of International Application No. PCT/JP2017/042414 filed Nov. 27, 2017 which designated the U.S. and claims priority to Japanese Patent Application No. 2016-231781 filed Nov. 29, 2016, the contents of which are incorporated herein by reference.

### TECHNICAL FIELD

The present invention relates to a cruise control device configured to cause an own vehicle to follow a preceding vehicle cruising ahead of the own vehicle in a cruising direction thereof.

### BACKGROUND

Typically, adaptive cruise control (ACC) for selecting a preceding vehicle from other vehicles present around a vehicle in front of the vehicle in a cruising direction thereof and causing the vehicle to follow the preceding vehicle has been realized. In the ACC, acceleration control is performed such that a distance between the vehicle and the preceding vehicle reaches a target inter-vehicular distance to cause the vehicle to follow the selected preceding vehicle. In a case where there is no preceding vehicle, the control of holding the speed of the vehicle constant is made such that the speed of the vehicle reaches, e.g., a speed set by a driver or a speed limit on a road.

### SUMMARY

The present disclosure relates to a cruise control device applied to a vehicle including a target detection unit configured to detect targets present in the front of an own vehicle in a cruising direction thereof, including a following control unit configured to recognize, as a following target, a target for following among the targets detected by the target detection unit, to set a target acceleration such that the following is performed with a target inter-vehicular distance being maintained with respect to the following target, and to perform the following control of controlling the acceleration of the own vehicle based on the set target acceleration while the own vehicle is cruising to follow the following target, and setting the target acceleration such that the speed of the following target relative to the own vehicle is increased by a predetermined speed in a case where a distance between the own vehicle and the following target becomes shorter than the target inter-vehicular distance during the period of execution of the following control by the following control unit. The cruise control device includes a determination unit configured to determine whether a small vehicle switching state has occurred or not, the following target having been switched to the target different from the target recognized as the following target so far during the period of execution of the following control by the following control unit and the vehicle type of the switched target being a small vehicle in the small vehicle switching state; an upper limit storage unit configured to store, as an upper limit value, the target acceleration set before determination as the small vehicle switching state by the determination unit under a condition where the determination unit determines that the small vehicle switching state has occurred; and a target acceleration setting unit configured to set the target acceleration to equal to or lower than the upper limit value stored in the upper limit storage unit during a period until the following control performed for the target, which has been determined as the small vehicle, as the following target ends after the determination unit has determined that the small vehicle switching state has occurred.

### BRIEF DESCRIPTION OF THE DRAWINGS

In the accompanying drawings:

FIG. 1 is a schematic configuration diagram of a cruise control system according to the present embodiment;

FIG. 2 is a schematic view in a situation where a motorcycle cuts in during the period of execution of following control;

FIG. 3 is a control flowchart performed by a detection ECU according to the present embodiment;

FIG. 4 is a timing chart showing the forms of target acceleration control and typical control performed in a case where the following control is performed and the motorcycle cuts in during a period in which an own vehicle slows down; and

FIG. 5 is a timing chart showing the forms of the target acceleration control and the typical control performed in a case where the following control is performed and the motorcycle cuts in during a period in which the own vehicle accelerates.

### DETAILED DESCRIPTION OF THE PREFERRED EMBODIMENTS

A case in which a motorcycle cuts in between the preceding vehicle and the own vehicle during a period in which the ACC is performed for the preceding vehicle cruising ahead in a subject traffic lane as a traffic lane in which the own vehicle is cruising is assumed. In this case, the own vehicle changes an ACC control target from the preceding vehicle to the motorcycle. At this point, it is assumed that a distance between the own vehicle and the motorcycle becomes shorter than a target inter-vehicular distance. In the typical ACC, the own vehicle does not rapidly slow down to quickly reduce the distance between the own vehicle and the motorcycle to the target inter-vehicular distance, but the speed of the own vehicle is controlled such that the speed of the motorcycle relative to the own vehicle is increased by a predetermined speed to increase the distance between the own vehicle and the motorcycle little by little. In this manner, the control of eventually holding the target inter-vehicular distance is made.

In a situation where the motorcycle cuts in between the preceding vehicle and the own vehicle, if the motorcycle accelerates and overtakes a vehicle (hereinafter referred to as a second preceding vehicle) cruising ahead of the motorcycle before the distance between the motorcycle recognized as the ACC control target and the own vehicle is held at the target inter-vehicular distance, it is assumed that a relationship in which the speed of the motorcycle relative to the own vehicle is increased by the predetermined speed is held while the own vehicle also accelerates. For this reason, in a case where the motorcycle has overtaken the second preceding vehicle, there is a high probability that a distance between the second preceding vehicle that the motorcycle has overtaken and the own vehicle is shorter than the target inter-vehicular distance and the speed of the own vehicle relative to the second preceding vehicle becomes high. Thus, there is a probability that the own vehicle rapidly slows down.

The present disclosure has been made for solving the above-described problem, and a main object of the present disclosure is to provide a cruise control device capable of suppressing a distance between a second preceding vehicle and an own vehicle from becoming shorter than a target inter-vehicle distance when a following target accelerates and overtakes the second preceding vehicle.

The present disclosure relates to a cruise control device applied to a vehicle including a target detection unit configured to detect targets present in the front of an own vehicle in a cruising direction thereof, including a following control unit configured to recognize, as a following target, a target for following among the targets detected by the target detection unit, to set a target acceleration such that the following is performed with a target inter-vehicular distance being maintained with respect to the following target, and to perform the following control of controlling the acceleration of the own vehicle based on the set target acceleration while the own vehicle is cruising to follow the following target, and setting the target acceleration such that the speed of the following target relative to the own vehicle is increased by a predetermined speed in a case where a distance between the own vehicle and the following target becomes shorter than the target inter-vehicular distance during the period of execution of the following control by the following control unit. The cruise control device includes a determination unit configured to determine whether a small vehicle switching state has occurred or not, the following target having been switched to the target different from the target recognized as the following target so far during the period of execution of the following control by the following control unit and the vehicle type of the switched target being a small vehicle in the small vehicle switching state; an upper limit storage unit configured to store, as an upper limit value, the target acceleration set before determination as the small vehicle switching state by the determination unit under a condition where the determination unit determines that the small vehicle switching state has occurred; and a target acceleration setting unit configured to set the target acceleration to equal to or lower than the upper limit value stored in the upper limit storage unit during a period until the following control performed for the target, which has been determined as the small vehicle, as the following target ends after the determination unit has determined that the small vehicle switching state has occurred.

For example, a case is assumed, in which during a period in which a preceding vehicle cruising ahead in a subject traffic lane is recognized as the following target and the following control of performing following with the target inter-vehicular distance being maintained with respect to the preceding vehicle is performed, a vehicle (hereinafter referred to as an cut-in vehicle) cuts in between the preceding vehicle and the own vehicle. In this case, the own vehicle changes the target for following from the preceding vehicle to the cut-in vehicle. At this point, a distance between the own vehicle and the cut-in vehicle is shorter than the target inter-vehicular distance. For this reason, in typical following control, the control of controlling the speed of the own vehicle such that the speed of the cut-in vehicle relative to the own vehicle is increased by the predetermined speed to gradually increase the distance between the own vehicle and the cut-in vehicle to the target inter-vehicular distance is performed.

In a case where the cut-in vehicle accelerates to pass a vehicle (hereinafter referred to as a second preceding vehicle) cruising ahead of the cut-in vehicle before the distance between the cut-in vehicle recognized as the following target and the own vehicle increases to the target inter-vehicular distance, it is assumed that the speed of the own vehicle is controlled such that the speed of the cut-in vehicle relative to the own vehicle is increased by the predetermined speed while the own vehicle accelerates. At this point, in a case where the cut-in vehicle passes the second preceding vehicle, there is a high probability that a distance between the second preceding vehicle that the cut-in vehicle has passed and the own vehicle is shorter than the target inter-vehicular distance and the speed of the own vehicle relative to the second preceding vehicle is high. This leads to a probability that the own vehicle rapidly slows down. Particularly, in a case where the cut-in vehicle is a small vehicle, the cut-in vehicle can quickly change one's direction as compared to a vehicle type of medium size or larger, and therefore, the small vehicle can pass the second preceding vehicle with the inter-vehicular distance to the second preceding vehicle being reduced. In addition, the length of the small vehicle is shorter than that of a vehicle type of medium size or larger, and therefore, the probability that the distance between the own vehicle and the second preceding vehicle in the case where the small vehicle has passed the second preceding vehicle becomes shorter than the target inter-vehicular distance is higher than that in a case where the cut-in vehicle is a vehicle type of medium size or larger. Thus, the probability that the own vehicle rapidly slows down is relatively high.

Considering the above, the determination unit determines whether the small vehicle switching state has occurred or not, the following target having been switched to the target different from the target recognized as the following target so far during the period of execution of the following control by the following control unit and the vehicle type of switched target being the small vehicle in the small vehicle switching state. Under a condition where the determination unit determines that the small vehicle switching state has occurred, the target acceleration set before determination as the small vehicle switching state by the determination unit is stored as the upper limit value by the upper limit storage unit. Then, the target acceleration setting unit sets the target acceleration to equal to or lower than the upper limit value stored in the upper limit storage unit during the period until the following control performed for the target, which has been determined as the small vehicle, as the following target ends after the determination unit has determined that the small vehicle switching state has occurred. With this configuration, even when the small vehicle accelerates to pass the second preceding vehicle, the target acceleration is, during a period in which the own vehicle performs the following control targeted for the small vehicle, set not to exceed the target acceleration set for maintaining, at the target inter-vehicular distance, the distance to the target (the second preceding vehicle) targeted by the following control before switching of the following target to the small vehicle. Thus, after the small vehicle has passed the second preceding vehicle, the probability that the distance between the own vehicle and the second preceding vehicle becomes shorter than the target inter-vehicular distance can be suppressed low, and therefore, the probability that rapid deceleration of the own vehicle will need to be performed can be kept low.

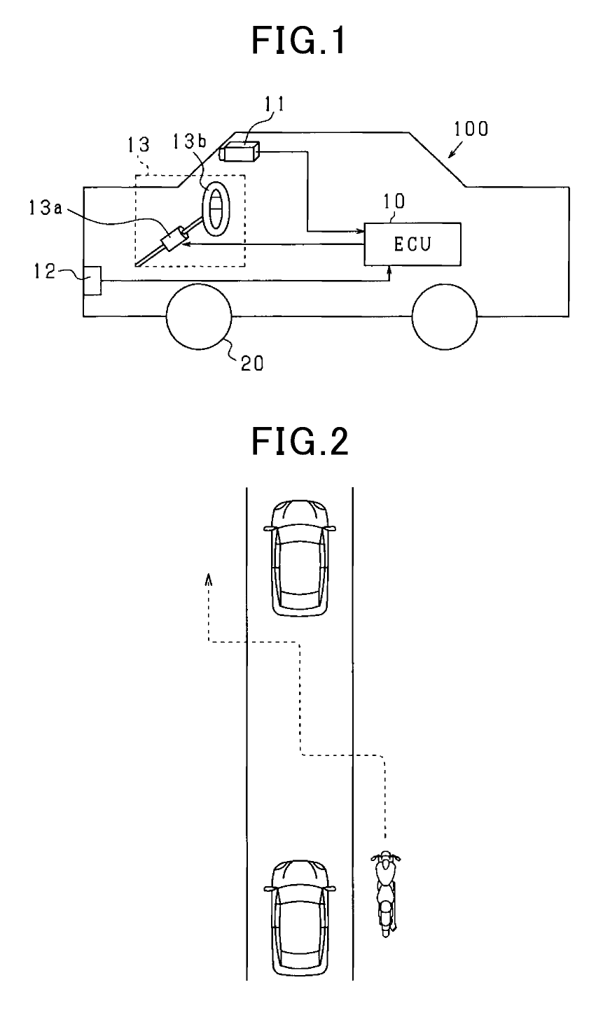

A cruise control system 100 applied to a vehicle configured to cruise by rotary driving of drive wheels 20 will be described with reference to FIG. 1. The cruise control system 100 includes a detection ECU 10, an image capturing device 11, a radar device 12, and an electrically-assisted power steering 13. The image capturing device 11 and the radar device 12 correspond to a target detection unit.

The image capturing device 11 includes, for example, a CCD camera, a CMOS image sensor, and a near-infrared camera. In this case, the image capturing device 11 is attached to a predetermined height at the center of an own vehicle in a vehicle width direction thereof, thereby capturing, from a panoramic view point, an image of a region extending across a predetermined angular range toward the front of the own vehicle. The image capturing device 11 is configured to extract a feature point of the captured image, the feature point indicating the presence of a target (referred to as an image detection target). Specifically, an edge point is extracted based on brightness information on the captured image, and Hough transform is performed for the extracted edge point. In Hough transform, a point on a straight line on which multiple edge points are continuously arranged or a point at which straight lines are at right angles to each other is extracted as the feature point. The image capturing device 11 performs, in every predetermined cycle, image capturing and feature point extraction, thereby transmitting a feature point extraction result to the detection ECU 10. Note that the image capturing device 11 may be a monocular camera or a stereo camera.

The radar device 12 is, for example, a well-known millimeter-wave radar using a high-frequency signal with a millimeter waveband as a transmission wave. The radar device 12 is provided at a front end portion of the own vehicle, and takes a region within a predetermined sensing angle as a sensing area where the target can be sensed. Moreover, the radar device 12 is configured to detect the position of a target (referred to as a radar detection target) within the sensing area. Specifically, a search wave is transmitted in a predetermined cycle, and a reflected wave is received by multiple antennas. A distance to the radar detection target is calculated from the transmission time of the search wave and the receipt time of the reflected wave. Moreover, a relative speed is calculated from the frequency of the reflected wave having been reflected on the radar detection target, the frequency having been changed due to a Doppler effect. In addition, the orientation of the radar detection target is calculated from a phase difference in the reflected wave received by the multiple antennas. Note that when the position and orientation of the radar detection target can be calculated, the position and distance of the radar detection target relative to the own vehicle can be identified. The radar device 12 is configured to perform, in every predetermined cycle, transmission of the search wave, reception of the reflected wave, and calculation of the relative position, the relative distance, and the relative speed, thereby transmitting the calculated relative position, distance, and speed to the detection ECU 10.

The image capturing device 11 and the radar device 12 are connected to the detection ECU 10. The detection ECU 10 is a computer including a CPU, a RAM, a ROM, an I/O, etc., and the CPU executes a program installed in the ROM to implement various functions. Thus, the detection ECU 10 corresponds to a following control unit, a determination unit, an upper limit storage unit, and a target acceleration setting unit.

In the present embodiment, there are multiple programs installed in the ROM. Specifically, the programs include an identical target determination program, a white line detection program, an inter-vehicular distance acquiring program, and a following control program.

The identical target determination program is for determining, based on radar detection target information and image detection target information, whether these targets indicate the same target or not.

Regarding a radar detection target position as the position obtained from the radar detection target and an image detection target position as the feature point obtained from the image detection target, those positioned close to each other are specifically associated with each other as those based on the same target. In a case where the image detection target position is present in the vicinity of the radar detection target position (in the present embodiment, an inter-target distance between the radar detection target position and the image detection target position is within a predetermined range), there is a high probability that the target is actually present at the radar detection target position. Such a state in which the position of the target is accurately acquired by the radar device 12 and the image capturing device 11 will be referred to as a fusion state. In the present embodiment, under a condition where it is determined that the radar detection target and the image detection target are in the fusion state, it is recognized that the target is present at the radar detection target position.

The white line detection program is for detecting, from information on the image shot by the image capturing device 11, a white line as a cruising section line for dividing a subject traffic lane.

Specifically, based on the brightness of the image shot by the image capturing device 11, the point of change in contrast (edge strength) between the white line dividing the traffic lane and a road surface is extracted as a candidate edge point. Then, a candidate boundary line is extracted from a series of extracted candidate edge points. More specifically, the image information acquired from the image capturing device 11 is continuously processed in a predetermined sampling cycle, and in the horizontal direction of the image, multiple points at which the brightness rapidly changes are extracted as the candidate edge points. Then, Hough transform is performed for the multiple extracted candidate edge points to acquire a series of candidate edge points, and multiple candidate lines taking the acquired candidate edge point series as right and left outlines are extracted.

Then, for each of the multiple candidate lines, the degree of having characteristics as the boundary line (the white line) for dividing the traffic lane is calculated at each candidate edge point, and the candidate line with the highest degree of having the characteristics is detected as the white line for dividing the traffic lane. Among the detected white lines, right and left white lines arranged close to the own vehicle and arranged to include the own vehicle are recognized as the white lines for dividing the traffic lane.

The inter-vehicular distance acquiring program is for recognizing, as a following target, a target present on the subject traffic lane estimated from the white lines detected by the white line detection program among the targets determined by the identical target determination program and acquiring an inter-vehicular distance between the own vehicle and the following target from the radar device 12.

The following control program corresponds to the steering processing of controlling a cruising direction of the own vehicle such that the own vehicle cruises to follow the following target under a condition where the following target is recognized on the subject traffic lane. Thus, the own vehicle includes the electrically-assisted power steering 13 as a safety device to be driven according to a steering command from the detection ECU 10.

The electrically-assisted power steering 13 includes a steering 13b configured to operate the steering angle of each drive wheel 20 provided at the vehicle and a steering electric motor 13a. The steering electric motor 13a is configured to generate steering force (torque) for assisting operating force for the steering 13b. As the torque increases, the steering angle of the drive wheel 20 increases. Moreover, the steering electric motor 13a is configured to generate steering force (torque) for operating the steering 13b in following control.

During a period in which the own vehicle is cruising to follow the following target, the following control program transmits a control command to a not-shown engine and a not-shown brake device such that the inter-vehicular distance, which is acquired by the inter-vehicular distance acquiring program, between the own vehicle and the following target is held at a target inter-vehicular distance. The target inter-vehicular distance is set according to the speed of the own vehicle. Specifically, a longer target inter-vehicular distance is set as the speed of the own vehicle increases.

For example, as illustrated in FIG. 2, a case is assumed, in which a preceding vehicle cruising ahead in the subject traffic lane is recognized as the following target and a motorcycle cuts in between the preceding vehicle and the own vehicle during a period in which the following control of maintaining the target inter-vehicular distance with respect to the preceding vehicle for following is performed. In this case, the own vehicle changes the target for following from the preceding vehicle to the motorcycle (recognizes the motorcycle as the following target). At this point, the inter-vehicular distance between the own vehicle and the motorcycle is shorter than the target inter-vehicular distance. For this reason, in typical following control, the control of controlling the speed of the own vehicle such that the speed of the motorcycle relative to the own vehicle is increased by a predetermined speed to gradually increase the inter-vehicular distance between the own vehicle and the motorcycle to the target inter-vehicular distance is performed.

In the above-described situation, a case is assumed, in which the motorcycle accelerates to pass a vehicle (hereinafter referred to as a second preceding vehicle) cruising ahead of the motorcycle before the inter-vehicular distance between the motorcycle recognized as the following target and the own vehicle increases to the target inter-vehicular distance. In this case, it is assumed that the speed of the own vehicle is controlled such that the speed of the motorcycle relative to the own vehicle is increased by the predetermined speed while the own vehicle accelerates. At this point, in a case where the motorcycle passes the second preceding vehicle, there is a high probability that the inter-vehicular distance between the second preceding vehicle that the motorcycle has passed and the own vehicle is shorter than the target inter-vehicular distance and the speed of the own vehicle relative to the second preceding vehicle is high. This leads to a probability that the own vehicle rapidly slows down. Particularly, the motorcycle can quickly change one's direction as compared to another type of vehicle other than a motorcycle, and therefore, can pass the second preceding vehicle with the inter-vehicular distance to the second preceding vehicle being reduced. In addition, the length of the motorcycle is shorter than those of another type of vehicle other than a motorcycle, and the motorcycle shows better acceleration than those of another type of vehicle other than a motorcycle. Thus, the probability that the inter-vehicular distance between the own vehicle and the second preceding vehicle in the case where the motorcycle has passed the second preceding vehicle becomes shorter than the target inter-vehicular distance and the speed of the own vehicle relative to the second preceding vehicle is high is assumed higher than that in a case where the cut-in vehicle is another type of vehicle other than a motorcycle.

In a case where the motorcycle cuts in between the own vehicle and the following target during the period in which the following control is performed, it is assumed that the inter-vehicular distance between the own vehicle and the motorcycle becomes shorter than the target inter-vehicular distance. Considering this assumption, the detection ECU 10 determines, during the period in which the following control targeted for the following target is performed, whether the inter-vehicular distance between the own vehicle and the following target becomes shorter than a predetermined distance or not. The predetermined distance is set to such a distance that the inter-vehicular distance between the own vehicle and the motorcycle is shorter than the target inter-vehicular distance and longer than a rapid deceleration distance as an inter-vehicular distance with the probability that the own vehicle rapidly slows down. In a case where it is determined that the inter-vehicular distance between the own vehicle and the following target becomes shorter than the predetermined distance, it is determined that there is a probability that the following target has been, due to target interruption, switched to a target different from the target recognized as the following target so far, and it is determined whether the vehicle type of following target is the motorcycle or not.

The vehicle type of following target is identified in such a manner that the brightness of the following target present in the image information transmitted by the image capturing device 11 is detected and pattern matching with a preset target template is performed based on the detected brightness. Specifically, the target template is, at the periphery of the position of the following target present on the image, moved little by little in a longitudinal direction and a lateral direction in a predetermined order, and pattern matching is performed at each position. Pattern matching at each position indicates the determination processing of calculating the degree of coincidence between the brightness of the image at such a position and the brightness of the target template and determining whether the calculated degree of coincidence is higher than a reference value or not.

In the determination processing, in a case where it is determined that a spot for which it is determined that the degree of coincidence between the brightness in the image and the brightness of the target template for the motorcycle is higher than the reference value is present at the periphery of the position of the following target, it is assumed that a similar target is present matching the target template for the motorcycle at the periphery of the position of the following target, and therefore, it is determined that the type of following target is the motorcycle.

Under a condition where there is a probability that the following target has been, due to target cutting in, switched to the target different from the target recognized as the following target so far and it is determined that the following target is the motorcycle (hereinafter referred to as a motorcycle switching state), a target acceleration or target speed set before determination as the motorcycle switching state is stored as an upper limit value.

During a period in which the following control targeted for the motorcycle is performed after determination as the motorcycle switching state, the target acceleration or target speed is set equal to or lower than the stored upper limit value.

In the present embodiment, in a case where the stored upper limit value is a negative value, the target acceleration or target speed is limited with the upper limit value being taken as an upper limit. A situation where the inter-vehicular distance between the preceding vehicle recognized as the following target and the own vehicle becomes shorter than the target inter-vehicular distance and the own vehicle accordingly slows down such that the inter-vehicular distance between the preceding vehicle and the own vehicle increases to the target inter-vehicular distance is assumed as a situation where the target acceleration or target speed is the negative value. In this situation, in a case where the motorcycle cuts in between the own vehicle and the preceding vehicle and it is determined that the following target has been switched to the motorcycle, the negative value of the target acceleration or target speed set before it is determined that the following target has been switched to the motorcycle is stored as the upper limit value. Then, the target acceleration or target speed is limited with the upper limit value being taken as the upper limit, and therefore, the own vehicle can continuously slow down even when the motorcycle accelerates. Consequently, the following control focusing on an increase in the inter-vehicular distance between the second preceding vehicle and the own vehicle to the target inter-vehicular distance can be performed.

In a case where the stored upper limit value is a positive value, the target acceleration or target speed is limited with zero being taken as the upper limit. A situation where the inter-vehicular distance between the preceding vehicle and the own vehicle is longer than the target inter-vehicular distance and the own vehicle accordingly accelerates such that the inter-vehicular distance between the preceding vehicle and the own vehicle decreases to the target inter-vehicular distance is assumed as a situation where the target acceleration or target speed is set to the positive value. In this situation, in a case where the motorcycle cuts in between the own vehicle and the preceding vehicle and it is determined that the following target has been switched to the motorcycle, the positive value of the target acceleration or target speed set before it is determined that the following target has been switched to the motorcycle is stored as the upper limit value. At this point, in a case where the target acceleration or target speed is limited with the upper limit value being taken as the upper limit, setting of the target acceleration or target speed to the positive value is allowed, and therefore, a situation where the own vehicle continuously accelerates might be caused in this case. In this case, there is a high probability that the inter-vehicular distance between the own vehicle and the second preceding vehicle after the motorcycle has passed the second preceding vehicle is shorter than the target inter-vehicular distance. Considering such a probability, in the case where the stored upper limit is the positive value, the target acceleration or target speed is limited with zero being taken as the upper limit. Thus, during a period until the following control targeted for the interrupt motorcycle ends, the own vehicle does not necessarily speed up, and the probability that the inter-vehicular distance between the own vehicle and the second preceding vehicle becomes shorter than the target inter-vehicular distance after the motorcycle as the following target has passed the second preceding vehicle can be suppressed low.

In the present embodiment, the control of setting the above-described target acceleration or target speed to equal to or lower than the upper limit value is canceled under a condition where the inter-vehicular distance is longer than the predetermined distance. Thus, even when the following target is switched to the motorcycle, if the inter-vehicular distance between the own vehicle and the motorcycle is longer than the predetermined distance, the inter-vehicular distance between the second preceding vehicle and the own vehicle can be held at a distance longer than the above-described rapid deceleration distance by at least the length of the motorcycle. Thus, in this situation, it is assumed that the probability that the own vehicle rapidly slows down is low even if the motorcycle passes the second preceding vehicle at any moment, and therefore, the control of setting the target acceleration or target speed to equal to or lower than the upper limit value is preferably canceled. Consequently, the following control focusing on the inter-vehicular distance to the second preceding vehicle can be performed.

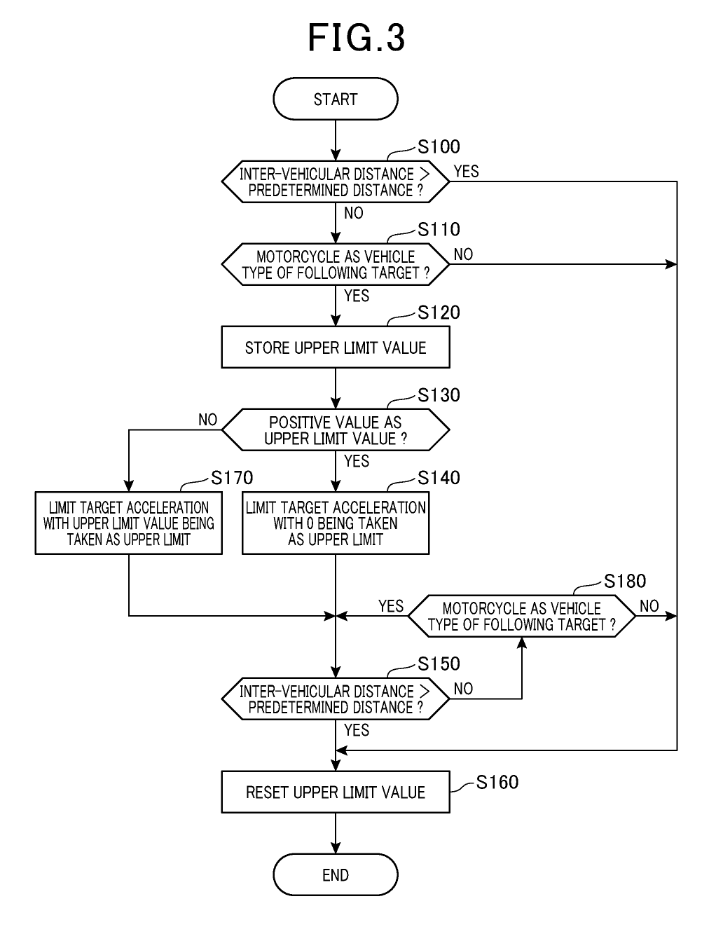

In the present embodiment, a later-described target acceleration (or target speed) control illustrated in FIG. 3 is performed by the detection ECU 10. In the target acceleration (or target speed) control illustrated in FIG. 3, the following target cruising ahead in the subject traffic lane is detected. The target acceleration (or target speed) control is performed during a period in which the following control for following after following of the detected target is performed.

First, at step S100, it is determined whether the inter-vehicular distance between the own vehicle and the following target is longer than the predetermined distance or not. In the case of NO determination in the determination processing at step S100, the processing proceeds to step S110. At step S110, it is determined whether the vehicle type of following target is the motorcycle or not. In the case of YES determination in the determination processing at step S110, the processing proceeds to step S120, and the target acceleration or target speed set before it is determined that the vehicle type of following target is the motorcycle is stored as the upper limit value.

At step S130, it is determined whether the upper limit value stored at step S120 is the positive value or not. In the case of NO determination in the determination processing at step S130, the processing proceeds to step S170, and the control of limiting the target acceleration or target speed with the stored upper limit value being taken as the upper limit is performed. Then, the processing proceeds to a later-described step S150. In the case of YES determination in the determination processing at step S130, the processing proceeds to step S140, and the control of limiting the target acceleration or target speed with zero being taken as the upper limit is performed. Then, the processing proceeds to step S150.

At step S150, it is determined whether the inter-vehicular distance between the own vehicle and the following target is longer than the predetermined distance or not. In the case of YES determination in the determination processing at step S150, the processing proceeds to step S160. At step S160, the upper limit value stored at step S120 is reset, and the control performed at step S140 or step S170 is canceled. Then, the present control ends.

In the case of NO determination in the determination processing at step S150, the processing proceeds to step S180. At step S180, it is determined whether the vehicle type of following target is the motorcycle or not. In the case of YES determination in the determination processing at step S180, the processing returns to step S150.

In the case of YES determination in the determination processing at step S100, the case of NO determination in the determination processing at step S110, or the case of NO determination in the determination processing at step S180, the processing proceeds to step S160.

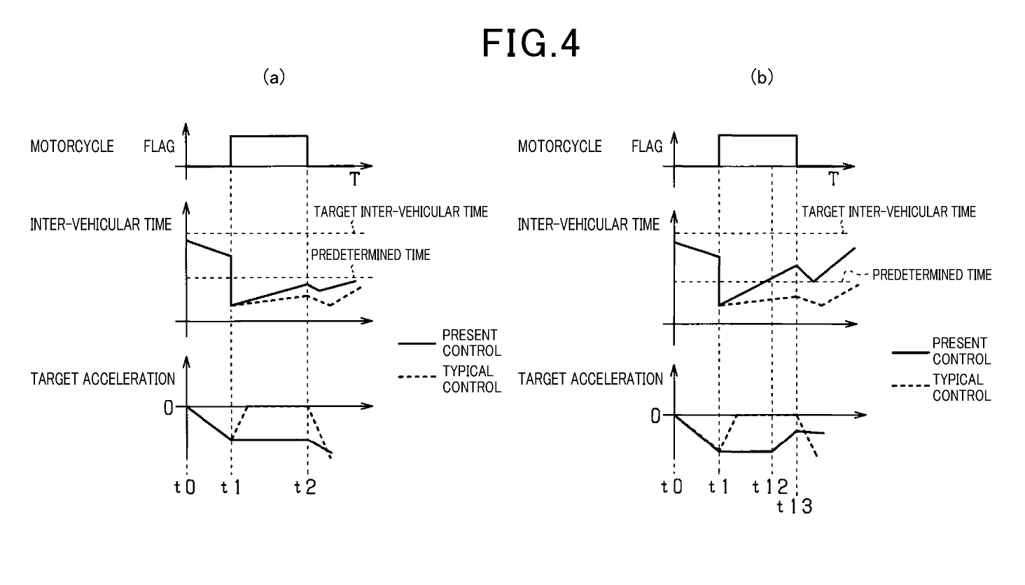

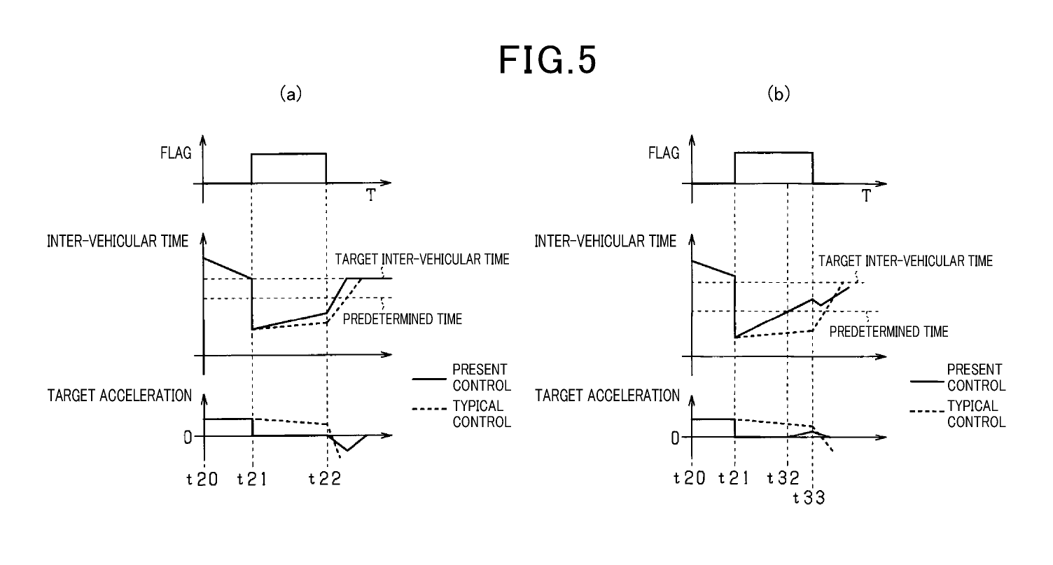

Next, operation in the target acceleration (or target speed) control executed by the detection ECU 10 will be described with reference to FIGS. 4 and 5. Note that both of FIGS. 4 and 5 illustrate the present control as solid lines and typical control as dashed lines.

In FIGS. 4 and 5, a “MOTORCYCLE FLAG” indicates, by high/low, whether the vehicle type of following target is identified as the motorcycle or not. “INTER-VEHICULAR TIME” indicates an estimated time length taken until the own vehicle passes the same position as the position that the following target has passed at a certain moment (referred to as reference time) after the reference time. A “TARGET ACCELERATION” indicates a target acceleration value set by the detection ECU 10 in the following control.

Both of FIGS. 4(a) and 4(b) assume a situation where the inter-vehicular time to the preceding vehicle recognized as the following target becomes shorter than target inter-vehicular time. The target inter-vehicular time is a value obtained in such a manner that the target inter-vehicular distance is divided by the cruising speed of the own vehicle.

In such a situation, the target acceleration or target speed of the own vehicle is, in both of FIGS. 4(a) and 4(b), set to the negative value such that the speed of the preceding vehicle relative to the own vehicle is increased by the predetermined speed (see time t0 to t1). At this point, although the target acceleration or target speed is set to the negative value, the inter-vehicular time to the preceding vehicle continuously decreases, and therefore, it is assumed that the speed of the own vehicle relative to the preceding vehicle is still high. For this reason, the target acceleration or target speed is set to increase in a negative direction over time.

Typically, even when a situation where the inter-vehicular time significantly decreases is caused during a period in which such control is performed (see the time t1), the control of setting the target acceleration or target speed such that the speed of the following target relative to the own vehicle is increased by the predetermined speed is continued. At this point, when the following target (the motorcycle) accelerates to pass the second preceding vehicle, a situation where the speed of the following target relative to the own vehicle is higher by the predetermined speed has occurred. In this case, even when the inter-vehicular distance between the own vehicle and the following target is shorter than the target inter-vehicular distance, a relationship in which the speed of the following target relative to the own vehicle is higher by the predetermined speed is maintained on a preferential basis, and therefore, the target acceleration or target speed increases from the negative value. During a period in which such control is performed, in a case where the following target is switched from the motorcycle to another target and the speed of the own vehicle relative to the following target increases accordingly (see time t2 of FIG. 4(a) or time t13 of FIG. 4(b)), the inter-vehicular distance between the own vehicle and the following target is shorter than the target inter-vehicular distance, and therefore, the target acceleration or target speed is set to the negative value.

On the other hand, in the present control, in a case where the inter-vehicular time becomes shorter than predetermined time due to a significant decrease in the inter-vehicular time, it is determined whether the following target is the motorcycle or not. Then, when it is determined that the following target is the motorcycle (see the time t1), the negative value of the target acceleration or target speed set before the inter-vehicular time becomes shorter than the predetermined time and it is determined that the following target is the motorcycle is stored as the upper limit value. Then, the target acceleration or target speed is limited with the stored upper limit value being taken as the upper limit. In FIGS. 4(a) and 4(b), a situation where the motorcycle accelerates to increase the speed and the speed of the motorcycle relative to the own vehicle is higher than a predetermined speed is assumed. In this case, the target acceleration or target speed of the own vehicle is limited to the upper limit value, and therefore, the own vehicle continuously slows down. Accordingly, the speed of the motorcycle increases while the own vehicle slows down, and therefore, the inter-vehicular time increases over time. Note that in a case where it is determined that the following target has been switched to the motorcycle and the speed of the own vehicle relative to the motorcycle is high during a period in which the control of limiting the target acceleration or target speed with the upper limit value being taken as the upper limit is performed, the target acceleration or target speed is set lower than the upper limit value.

In FIG. 4(a), a case is assumed, in which it is determined that the following target has been switched from the motorcycle to another type of vehicle before the inter-vehicular time becomes longer than the predetermined time (see the time t2). In this situation, the stored upper limit value is reset, and the control of limiting the target acceleration or target speed with the upper limit value being taken as the upper limit is canceled. At this point, the inter-vehicular distance between the own vehicle and the following target is shorter than the target inter-vehicular distance, and the speed of the own vehicle relative to the following target is high. Thus, the control is made such that the target acceleration or target speed increases in the negative direction. Accordingly, the inter-vehicular time is short during a period in which the speed of the own vehicle relative to the following target is high, but the speed of the following target relative to the own vehicle increases afterwards so that the inter-vehicular time can be increased.

In FIG. 4(b), a case is assumed, in which the inter-vehicular time becomes longer than the predetermined time before it is determined that the following target has been switched from the motorcycle to another type of vehicle (see time t12). In this case, the stored upper limit value is reset, and the control of limiting the target acceleration or target speed with the upper limit value being taken as the upper limit is canceled. In association with cancellation of the control of limiting the target acceleration or target speed with the upper limit value being taken as the upper limit, the control is made such that the speed of the following target relative to the own vehicle is increased by the predetermined speed while the target acceleration or target speed is set to increase in a positive direction such that the own vehicle accelerates.

Then, when it is determined that the following target has been switched from the motorcycle to another type of vehicle, the following control targeted for the re-switched following target is performed (see time t13). At this point, the inter-vehicular distance between the own vehicle and the following target is shorter than the target inter-vehicular distance, and the speed of the own vehicle relative to the following target is high. Thus, the control is made such that the target acceleration or target speed increases in the negative direction. Accordingly, the inter-vehicular time is short during a period in which the speed of the own vehicle relative to the following target is high, but the speed of the following target relative to the own vehicle increases afterwards so that the inter-vehicular time can be increased.

In any of the situation of FIG. 4(a) and the situation of FIG. 4(b), the target acceleration or target speed can be controlled to the negative value after the following target has been switched to the motorcycle, and therefore, the amount of increase in the inter-vehicular time per unit time is greater as compared to the typical control. Thus, the inter-vehicular time when it is determined that the following target has been switched from the motorcycle to another type of vehicle is longer as compared to the typical control. Moreover, since the target acceleration or target speed is set to the negative value, the amount of temporal change in the target acceleration or target speed set when the following target is switched from the motorcycle to another type of vehicle is smaller as compared to the typical control. Thus, fluctuation in the acceleration of the own vehicle can be reduced as compared to the typical control.

Both of FIGS. 5(a) and 5(b) assume a situation where the inter-vehicular time to the following target is longer than the target inter-vehicular time. In this situation, the target acceleration or target speed is controlled to the positive value to control the inter-vehicular time to the target inter-vehicular time (see time t20 to t21).

Typically, even when a situation where the inter-vehicular time is significantly shortened during a period in which such control is performed is caused, the control of setting the target acceleration or target speed such that the speed of the following target relative to the own vehicle is increased by the predetermined speed is continued. At this point, when the following target (the motorcycle) accelerates to pass the second preceding vehicle, the speed of the motorcycle relative to the own vehicle increases over time. In a case where the speed of the motorcycle relative to the own vehicle is still lower than the predetermined speed, the target acceleration or target speed is decreased little by little over time to bring a relationship in which the speed of the motorcycle relative to the own vehicle is higher by the predetermined speed (the time t21 to t22 of FIG. 5(a) or the time t21 to t33 of FIG. 5(b)). During a period in which such control is performed, in a case where the speed of the own vehicle relative to the motorcycle increases (the time t22 of FIG. 5(a) or the time t33 of FIG. 5(b)), the target acceleration or target speed is decreased because the inter-vehicular distance between the own vehicle and the following target is shorter than the target inter-vehicular distance.

On the other hand, in the present control, in a case where the inter-vehicular time becomes shorter than the predetermined time due to a significant decrease in the inter-vehicular time, it is determined whether the following target is the motorcycle or not. Then, when it is determined that the following target is the motorcycle (see the time t21), the positive value of the target acceleration or target speed set before the inter-vehicular time becomes shorter than the predetermined time and it is determined that the following target is the motorcycle is stored as the upper limit value. The upper limit value is the positive value, and therefore, the target acceleration or target speed is limited with zero being taken as the upper limit in this case.

In FIGS. 5(a) and 5(b), a situation is assumed, in which the motorcycle recognized as the following target accelerates to increase the speed and the speed of the motorcycle relative to the own vehicle becomes higher than the predetermined speed. In this case, the target acceleration or target speed of the own vehicle is limited to zero, and it is not necessary to speed up the own vehicle. Accordingly, the speed of the motorcycle increases while the speed of the own vehicle is maintained constant. Thus, the inter-vehicular time increases over time.

In FIG. 5(a), a case is assumed, in which it is determined that the following target has been switched from the motorcycle to another type of vehicle before the inter-vehicular time becomes longer than the predetermined time (see the time t22). In this situation, the stored upper limit value is reset, and the control of limiting the target acceleration or target speed with the upper limit value being taken as the upper limit is canceled. Note that the inter-vehicular time to the re-switched following target is shorter than the target inter-vehicular time and the speed of the own vehicle relative to the following target is increased, and therefore, the target acceleration or target speed is decreased. Thus, the inter-vehicular time can be increased to the target inter-vehicular time. In a case where the inter-vehicular time can be increased to the target inter-vehicular time, the target acceleration or target speed is set to zero to maintain the inter-vehicular time at the target inter-vehicular time.

In FIG. 5(b), a case is assumed, in which the inter-vehicular time becomes longer than the predetermined time before it is determined that the following target has been switched from the motorcycle to another type of vehicle (see the time t32). In this case, the stored upper limit value is reset, and the control of limiting the target acceleration or target speed with zero being taken as the upper limit is canceled. In association with cancellation of the control of limiting the target acceleration or target speed with zero being taken as the upper limit, the control is made such that the speed of the following target relative to the own vehicle is increased by the predetermined speed while the target acceleration or target speed is set to increase in the positive direction such that the own vehicle accelerates.

Then, when it is determined that the following target has been switched from the motorcycle to another type of vehicle, the following control targeted for the re-switched following target is performed (see the time t33). At this point, the inter-vehicular time to the re-switched following target is shorter than the target inter-vehicular time, and the speed of the own vehicle relative to the following target is high. Thus, the target acceleration or target speed is decreased. Accordingly, the inter-vehicular time is short during a period in which the speed of the own vehicle relative to the following target is high, but the speed of the following target relative to the own vehicle increases afterwards so that the inter-vehicular time can be increased.

In any of the situation of FIG. 5(a) and the situation of FIG. 5(b), the target acceleration or target speed is set to zero after the following target has been switched to the motorcycle as long as the inter-vehicular time does not exceed the predetermined time. During such a period, it is not necessary to speed up the own vehicle. Thus, the amount of increase in the inter-vehicular time per unit time is greater as compared to the typical control. Thus, the inter-vehicular time when it is determined that the following target has been switched from the motorcycle to another type of vehicle is longer as compared to the typical control. Moreover, the target acceleration or target speed is set to the positive value in the typical control while the target acceleration or target speed is set to zero in the present control. Thus, the amount of temporal change in the target acceleration or target speed set when the following target has been switched from the motorcycle to another type of vehicle is smaller as compared to the typical control. Consequently, fluctuation in the acceleration of the own vehicle can be reduced as compared to the typical control.

With the above-described configuration, the present embodiment provides the following advantageous effects.

Under a condition where it is determined that the motorcycle switching state has occurred, the target acceleration or target speed set before determination as the motorcycle switching state is stored as the upper limit value. During a period until the following control performed for the motorcycle as the following target ends after determination as the motorcycle switching state, the target acceleration or target speed is set equal to or lower than the upper limit value. Thus, even when the motorcycle accelerates to pass the second preceding vehicle, the target acceleration or target speed is, during a period in which the own vehicle performs the following control targeted for the motorcycle, set not to exceed the target acceleration or target speed set for maintaining, at the target inter-vehicular distance, the inter-vehicular distance to the target (the second preceding vehicle) targeted by the following control before switching of the following target to the motorcycle. Thus, after the motorcycle has passed the second preceding vehicle, the probability that the inter-vehicular distance between the own vehicle and the second preceding vehicle becomes shorter than the target inter-vehicular distance can be suppressed low, and therefore, the probability that rapid deceleration of the own vehicle is performed can be suppressed low.

The motorcycle is a vehicle having a shorter length as compared to other types of vehicles and exhibiting favorable acceleration. Thus, in a situation where the motorcycle cuts in between the own vehicle and the preceding vehicle and accelerates to pass the second preceding vehicle, there is a high probability that the own vehicle also accelerates to follow the motorcycle, the inter-vehicular distance to the second preceding vehicle is shortened accordingly, and therefore, the own vehicle rapidly slows down after the motorcycle has passed the second preceding vehicle. Thus, in a case where the vehicle cutting in between the own vehicle and the preceding vehicle is the motorcycle, the present control is especially preferably performed.

The vehicle type of following target is analyzed based on the information on the image captured by the image capturing device 11, and therefore, it can be accurately determined whether the following target is the motorcycle or not.

Among many types of typical following control, one is made such that the target inter-vehicular distance is set longer as the speed of the own vehicle increases. When the following control is performed in a situation in which the motorcycle cuts in between the own vehicle and the preceding vehicle and accelerates to pass the second preceding vehicle, the own vehicle also accelerates. At this point, the speed increases in association with acceleration of the own vehicle, and the target inter-vehicular distance is set long. Thus, after the motorcycle has passed the second preceding vehicle, the probability that the inter-vehicular distance between the own vehicle and the second preceding vehicle becomes shorter than the target inter-vehicular distance is higher as compared to the case of a fixed value of the target inter-vehicular distance. In this case, there is a probability that the own vehicle rapidly slows down due to a shorter inter-vehicular distance between the own vehicle and the second preceding vehicle than the target inter-vehicular distance. Thus, in the case of performing the following control of setting a longer target inter-vehicular distance as the speed of the own vehicle increases, the present control is especially preferably applied to reduce rapid deceleration.

Note that the above-described embodiment may be changed and implemented as follows. Note that the following other configuration examples may be separately applied to the configuration of the above-described embodiment, or may be applied in combination as necessary.

In the above-described embodiment, the target inter-vehicular distance is set according to the speed of the own vehicle. On this point, the target inter-vehicular distance may be a fixed value.

The cruise control system 100 according to the above-described embodiment includes the image capturing device 11. On this point, the image capturing device 11 is not necessarily provided. In this case, the determination processing, which is performed due to switching of the following target to another target during the period of execution of the following control, on whether the following target is the motorcycle or not is performed based on the information acquired by the radar device 12. One example of the method for determining, based on the information acquired by the radar device 12, whether the following target is the motorcycle or not is a method in which the vehicle width of the following target is calculated based on the information acquired by the radar device 12 and it is determined that the following target is the motorcycle in a case where the calculated vehicle width is substantially equal to the pre-stored width of the motorcycle.

In the above-described embodiment, in a case where it is determined that there is a probability that the following target has been, due to target cutting in, switched to the target different from the target recognized as the following target so far, it is determined whether the following target is the motorcycle or not. On this point, it may be determined whether the following target is a small vehicle including the motorcycle or not.

In the above-described embodiment, the upper limit of the target acceleration or target speed is changed based on whether the stored upper limit value is the negative or positive value. On this point, regardless of whether the stored upper limit value is the negative or positive value, the target acceleration or target speed may be limited with a value lower than the stored upper limit value by a predetermined value being taken as the upper limit.

In the above-described embodiment, the predetermined distance is set shorter than the target inter-vehicular distance. On this point, the predetermined distance may be set equal to the target inter-vehicular distance. If the inter-vehicular distance between the interrupt motorcycle and the own vehicle can be the predetermined distance, the inter-vehicular distance between the second preceding vehicle and the own vehicle can be held at a distance longer than the target inter-vehicular distance by at least the length of the motorcycle. Thus, in the following control performed after the motorcycle has passed the second preceding vehicle and targeted for the second preceding vehicle, the inter-vehicular distance between the second preceding vehicle and the own vehicle can be controlled to the target inter-vehicular distance by slight acceleration. Alternatively, the predetermined distance may be set longer than the target inter-vehicular distance.

In the above-described embodiment, in a case where it is determined that the inter-vehicular distance between the own vehicle and the following target becomes shorter than the predetermined distance, it is determined that there is a probability that the following target has been, due to target cutting in, switched to the target different from the target recognized as the following target so far. On this point, in a case where it is determined that the amount of decrease in the inter-vehicular distance between the own vehicle and the following target per unit time becomes greater than a predetermined amount, it may be determined that there is a probability that the following target has been, due to target cutting in, switched to the target different from the target recognized as the following target so far.

The present disclosure has been described according to the embodiments, but it is understood that the present disclosure is not limited to these embodiments and structures. The present disclosure also includes various modifications and modifications within an equivalent scope. In addition, not only various combinations and forms but also other combinations and forms including more, less, or a single element are also within the scope and sprit of the present disclosure.

What is claimed is:

1. A cruise control device applied to a vehicle including a target detection unit configured to detect targets present in front of an own vehicle in a cruising direction thereof, including a following control unit configured to recognize, as a following target, a target for following among the targets detected by the target detection unit, to set a target acceleration such that the following is performed with a target inter-vehicular distance being maintained with respect to the following target, and to perform a following control of controlling an acceleration of the own vehicle based on the set target acceleration while the own vehicle is following the following target, and setting the target acceleration such that a speed of the following target relative to the own vehicle is increased by a predetermined speed in a case where a distance between the own vehicle and the following target becomes shorter than the target inter-vehicular distance during a period of execution of the following control by the following control unit, the cruise control device comprising:
a determination unit configured to determine whether a small vehicle switching state has occurred or not, the following target having been switched to the target different from the target recognized as the following target so far during the period of execution of the following control by the following control unit and a vehicle type of the switched target being a small vehicle in the small vehicle switching state;
an upper limit storage unit configured to store, as an upper limit value, the target acceleration set before determination as the small vehicle switching state by the determination unit under a condition where the determination unit determines that the small vehicle switching state has occurred; and
a target acceleration setting unit configured to set the target acceleration to equal to or lower than the upper limit value stored in the upper limit storage unit during a period until the following control performed for the target, which has been determined as the small vehicle, as the following target ends after the determination unit has determined that the small vehicle switching state has occurred.

2. The cruise control device according to claim 1, wherein
the target acceleration setting unit cancels the control of setting the target acceleration to equal to or lower than the upper limit value under a condition where the distance between the own vehicle and the following target is longer than a predetermined distance.

3. The cruise control device according to claim 1, wherein
the determination unit determines that the following target has been switched to the target different from the target recognized as the following target under a condition where the distance between the own vehicle and the following target becomes shorter than the predetermined distance during the period of execution of the following control.

4. The cruise control device according to claim 2, wherein
the predetermined distance is a distance shorter than the target inter-vehicular distance and longer than a rapid deceleration distance required to avoid the own vehicle if the own vehicle rapidly slows down.

5. The cruise control device according to claim 2, wherein
the predetermined distance is set equal to the target inter-vehicular distance.

6. The cruise control device according to claim 1, wherein
in a case where the upper limit value stored in the upper limit storage unit is a negative value, the target acceleration setting unit limits the target acceleration with the upper limit value being taken as an upper limit.

7. The cruise control device according to claim 1, wherein
in a case where the upper limit value stored in the upper limit storage unit is a positive value, the target acceleration setting unit limits the target acceleration with zero being taken as the upper limit.

8. The cruise control device according to claim 1, wherein
the switched following target is a motorcycle, and
the target acceleration setting unit is configured to use the upper limit storage unit as the motorcycle accelerates, even in a situation where the motorcycle has accelerated to pass the target that has been recognized as the following target so far, the own vehicle is prevented from approaching the target which has been recognized as the following target before the motorcycle at an acceleration exceeding the stored upper limit.

9. The cruise control device according to claim 1, wherein
the target detection unit includes an image capturing device configured to capture at least an image in front of the own vehicle in the cruising direction thereof, and
the determination unit determines, based on information on the image captured by the image capturing device, whether a type of the following target is the small vehicle.

10. The cruise control device according to claim 1, wherein
the target inter-vehicular distance is set longer as a speed of the own vehicle increases.

11. A cruise control device applied to a vehicle including a target detection unit configured to detect targets present in front of an own vehicle in a cruising direction thereof, including a following control unit configured to recognize, as a following target, a target for following among the targets detected by the target detection unit, to set a target acceleration or target speed such that the following is performed with a target inter-vehicular distance being maintained with respect to the following target, and to perform a following control of controlling an acceleration of the own vehicle based on the set target acceleration or target speed while the own vehicle is following the following target, and setting the target acceleration or target speed such that a speed of the following target relative to the own vehicle is increased by a predetermined speed in a case where a distance between the own vehicle and the following target becomes shorter than the target inter-vehicular distance during a period of execution of the following control by the following control unit, the cruise control device comprising:
a determination unit configured to determine whether a small vehicle switching state has occurred or not, the following target having been switched to the target different from the target recognized as the following target so far during the period of execution of the following control by the following control unit and a vehicle type of the switched target being a small vehicle in the small vehicle switching state;
an upper limit storage unit configured to store, as an upper limit value, the target acceleration or target speed set before determination as the small vehicle switching state by the determination unit under a condition where the determination unit determines that the small vehicle switching state has occurred; and
a target acceleration setting unit configured to set the target acceleration or target speed to equal to or lower than the upper limit value stored in the upper limit storage unit during a period until the following control performed for the target, which has been determined as the small vehicle, as the following target ends after the determination unit has determined that the small vehicle switching state has occurred.
